(19) United States
(12) Patent Application Publication
(10) Pub. No.: US 2001/0056510 A1
(43) Pub. Date: Dec. 27, 2001

(54) Electronic apparatus, system and method for communicating function data through a bus

(75) Inventor: Takero Kobayashi, Tokyo (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/886,040

(22) Filed: Jun. 22, 2001

(30) Foreign Application Priority Data
Jun. 23, 2000 (JP) P2000-188860

(51) Int. Cl. G06F 3/00; G06F 3/02; G06F 3/023; G06F 3/05; G06F 13/00

(52) U.S. Cl. 710/36; 710/100

(57) ABSTRACT

An electronic method and apparatus for a communication system coupling a target device and a plurality of accessing devices to a bus. One of the plurality of accessing devices requests access to the target device. The target device then acquires GUID data from the requesting device. The acquired GUID data is compared to preliminary GUID data stored in the target device. When the acquired GUID data coincides with the preliminary GUID data, the target device releases access allowing function data to the accessing device. On the other hand, when the acquired GUID data does not coincide with the preliminary GUID data, the target electronic apparatus releases access prohibiting function data to the accessing device.

### BACKGROUND OF THE INVENTION

1. Field of the Invention

The present invention relates to communication methods and devices, and more particularly, to such devices and methods for communicating known function data at a high speed among devices coupled through a serial bus and for switching known function data between nodes coupled through a serial bus. Discussion of the Related Art

Typically, IEEE 1394 is a standard related to a serial bus that couples a plurality of nodes of information processing devices in order to transmit and receive data at a high speed. Particularly, IEEE 1394 is intended for coupling a personal computer (PC) and devices such as a digital video camera, a hard disk drive (HDD), a magnet optic (MO) and the like. Further, IEEE 1394 maybe used for coupling a digital broadcasting receiving apparatus and a digital television.

In order to facilitate communication among a plurality of devices coupled through the serial bus, advanced protocol standards such as the serial bus protocol-2 (hereinafter, simply referred to as “SBP2”) and the audio video control protocol (hereinafter referred to as “AV/C”), have been developed. These advanced protocol standards are based on the IEEE 1394 serial bus standard. In order to simplify the description, an electronic apparatus coupled through an IEEE 1394 high speed serial bus is hereinafter referred to as a “1394 device”.

Each of the 1394 devices coupled through the IEEE 1394 serial bus may recognize each function offered from other 1394 devices communicating data. Thus, each 1394 device associates unique data to a node on the bus. This unique data is described in a configuration ROM area of each device connected to the IEEE 1394 bus. By reading the unique data in the configuration ROM at a target node, another node may recognize the target node as a 1394 device. In order to communicate with the 1394 device at the target, the other node may obtain the advanced protocol for the serial bus.

For example, an HDD corresponding to the IEEE 1394 bus (hereinafter, referred to as a 1394 HDD) is usually controlled by the advanced communication protocol SBP2 on the IEEE 1394 serial bus. Communication protocol SBP2 defines a small computer system interface (SCSI) command set in order to couple a PC and a 1394 HDD. Thus, the configuration ROM in the 1394 HDD stores a described notice that this node has the SBP2 corresponding functions.

On the other hand, when a PC operates at an IEEE 1394 node utilizing the 1394 HDD, and enters a bus reset phase by notifying a topology variation of the IEEE 1394 serial bus and by a variation of the node status, the PC detects available 1394 devices by reading the content in a configuration ROM for each respective IEEE 1394 node. Then, the PC performs an initializing process for utilizing the IEEE 1394 nodes based on the respective control protocols.

Conventionally, each respective IEEE 1394 device may access all other 1394 devices coupled through the IEEE 1394 bus. Namely, the content data stored at a 1394 node may be updated from all other 1394 nodes coupled through the IEEE 1394 serial bus. Consequently, this configuration may generate inconsistency between real data stored in a 1394 HDD and required data from another IEEE 1394 node, after one IEEE 1394 node has updated the data contents in the 1394 HDD. For example, when one IEEE 1394 device has initially updated the HDD data, e.g., FAT (File Allocation Table) and dictionary data, another IEEE 1394 device requires the original data stored in the 1394 HDD even though the data may have already been updated during a previous access by a different device node.

Accordingly, the conventional apparatus and method for communicating among 1394 devices experience serious shortcomings. These shortcomings are apparent even if the 1394 device can be accessed from all 1394 nodes coupled through the 1394 serial bus. Thus, there is a need for an apparatus, system and method for performing reliable communication among electronic apparatus coupled through the IEEE 1394 serial bus substantially obviating the above-mentioned problems and defects of a conventional apparatus and method.

### SUMMARY OF THE INVENTION

In accordance with the purpose of the invention as embodied and broadly described, the invention provides in a communication system an electronic apparatus, coupled to a target device and a plurality of accessing devices coupled through a bus connection. The electronic apparatus comprises: means for storing function data for allowing or prohibiting access to the target device; means for communicating the function data of the target device to the plurality of accessing devices coupled through the bus connection; means for detecting a request for reading the function data made by one of the plurality of accessing devices; and means for selectively releasing a response providing either access allowing function data or access prohibiting function data based on a certification status of the requesting accessing devices.

Furthermore the invention provides a target electronic device for coupling a plurality of accessing devices through a bus connection, the target device comprises: means for detecting a request of one of the plurality of accessing devices for accessing the target device; means for acquiring GUID data for the accessing device; means for comparing the acquired GUID data to preliminary GUID data stored in the target device; and means for releasing an access allowing function data to the accessing device when the acquired GUID data coincides with the preliminary stored GUID data, and for releasing an access prohibiting function data when the acquired GUID data does not coincide with the preliminary stored GUID data.

Still further the invention provides in a system including a target apparatus having a communicating means and a plurality of electronic devices capable of communications with the target apparatus through the communicating means. The target apparatus comprises: means for storing a first function data and a second function data; means for performing a certification process for certifying the plurality of electronic devices; means for detecting a request for reading function data of the target apparatus from one of the plurality of electronic devices; means for judging whether the reading request is made by one of the plurality of electronic devices having a certification; and means for transmitting the first function data if the judging means determines that the request was made by one of the plurality of electronic devices having the certification and transmitting the second function data if the judging means determines that the request was made by one of the plurality of electronic devices having no certification.

Additionally the invention provides a method for controlling communication among an electronic device serving as a target node and a plurality of electronic devices serving as accessing nodes and coupled to the target node through a serial bus connection. The method comprises: storing function data for authorizing access to the target node; detecting a request for reading the function data from one of the plurality of accessing nodes; determining whether the request is made by one of the plurality of accessing nodes having a certification; and generating a response for releasing function data allowing access to the target node based on the determination.

Furthermore, the invention provides a method for communicating data between a target node and a plurality of accessing nodes coupled to the target node through a bus. The method comprises: performing a certification process for certifying one of the plurality of accessing nodes to access the target node; detecting a request of one of the plurality of accessing nodes for accessing the target node; judging whether the request is made by the certified node; and transmitting access allowing data to the certified node.

Still further, the invention provides a method for communicating among a target device and a plurality of accessing devices coupled to the target device through a bus connection, comprising: detecting a request of one of the plurality of accessing devices for accessing the target device; acquiring GUID data for the requesting accessing device; comparing to the acquired GUID data to preliminary GUID data stored in the target electronic apparatus; releasing access allowing function data to the requesting accessing device when the acquired GUID data coincides with the preliminary GUID data; and releasing access prohibiting function data to the requesting accessing device when the acquired GUID data does not coincide with the preliminary GUID data.

Additionally, the invention provides a system for communicating data among a plurality of devices coupled through a bus connection comprising: an electronic device, for selectively communicating stored function data of a second device to one of a plurality of third devices based on a certification status of the third device; a target device, corresponding to the second device, for acquiring data from one of the plurality of third devices and releasing function data based on a comparison between the acquired data and preliminary stored data; and a plurality of accessing devices, corresponding to the third device, for receiving function data of the target device based an authorization performed by at least one of the electronic device and target device as a result of a read request.

Additional objects and advantages of the invention will be set forth in the description that follows, and in part will be obvious from the description, or may be learned by practicing the invention. The objects and advantages of the invention may be realized and obtained by means of the instrumentalities and combinations particularly pointed out in the appended claims.

### BRIEF DESCRIPTION OF THE DRAWINGS

A more complete appreciation of the present invention and its many attendant advantages thereof will be readily obtained as the same becomes better understood by reference to the following detailed description when considered in connection with the accompanying drawings wherein:

FIG. 1 illustrates the general architecture of a 1394 HDD device consistent with the present invention;

FIG. 2 illustrates a first data structure of a configuration ROM consistent with the present invention;

FIG. 3 illustrates a second data structure of a configuration ROM consistent with the present invention;

FIG. 4 illustrates a third data structure of a configuration ROM consistent with the present invention;

FIG. 5 illustrates an embodiment of an IEEE 1394 bus configuration among a plurality of IEEE 1394 nodes consistent with the present invention;

FIG. 6 shows a flow diagram illustrating a first process request for reading the configuration ROM in a manner consistent with the present invention;

FIG. 7 illustrates a status of a node connection when each node completes reading a configuration ROM of a target node consistent with the present invention;

FIG. 8 shows a flow diagram illustrating processing of a request for certification in a manner consistent with the present invention;

FIG. 9 shows a flow diagram illustrating a process for detecting a certified 1394 node in a manner consistent with the present invention;

FIG. 10 shows a flow diagram illustrating a second process request for for reading the configuration ROM in a manner consistent with the present invention;

FIG. 11 is a block diagram illustrating a node connection after a second device reads the configuration ROM consistent with the present invention; and

FIG. 12 shows a flow diagram illustrating a switch of the configuration ROM in a manner consistent with the present invention.

Reference will now be made in detail to embodiments consistent with the present invention, examples of which are illustrated in accompanying drawings. Wherever possible, the same reference numbers will be used throughout the drawings to refer to the same or like parts:

### DETAILED DESCRIPTION

Embodiments consistent with the present invention provide systems and methods for controlling access to a 1394 device that solve the above-mentioned problems and defects. More particularly, embodiments consistent with the present invention provide a novel communication system and method for controlling access to a particular 1394 device, allowing access to a particular 1394 device by selectively offering access allowing data or access forbidding data depending upon the node requesting access to the particular 1394 device.

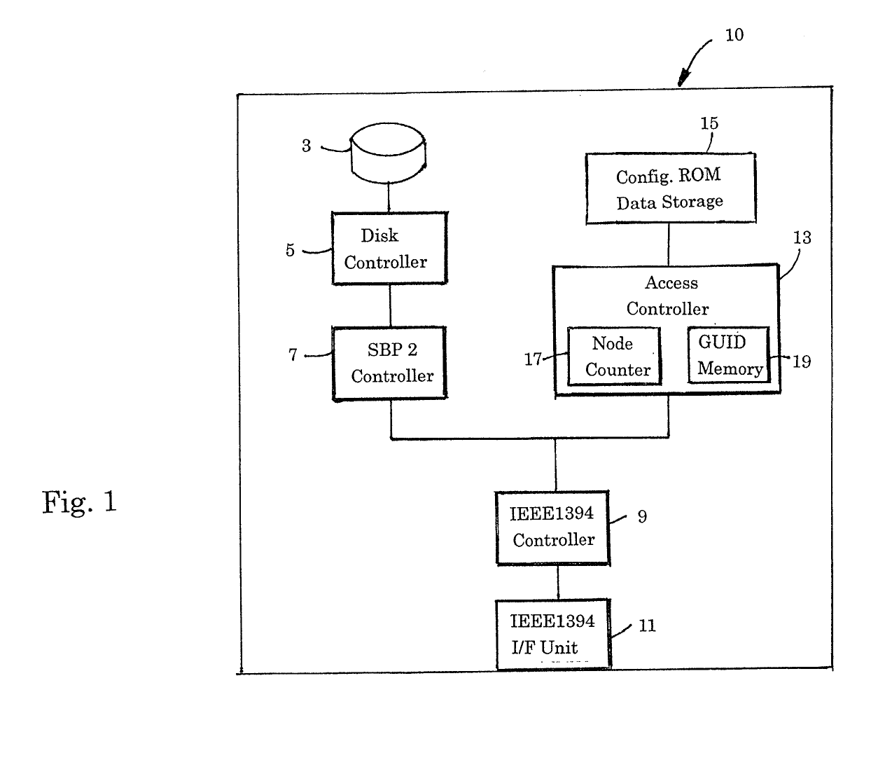

As illustrated in FIG. 1, a 1394 HDD device 10, includes a hard disk 3 of a magnetic disk medium, a hard disk controller 5 for controlling the operation of the hard disk 3, an SBP2 controller 7 for instructing SCSI commands to hard disk controller 5, an IEEE 1394 controller 9 for controlling IEEE transactions though an IEEE 1394 interface (I/F) unit 11, an access controller 13 coupled to IEEE 1394 controller 9 and a configuration ROM (hereinafter, referred to as config. ROM) data storage 15 for storing a plurality of config. ROM data, explained in detail below.

Thus, IEEE 1394 interface (I/F) unit 11 is a physical interface for coupling 1394 HDD device 10 to another SBP2 related device, i.e., an IEEE 1394 node, through IEEE 1394 cable (not shown).

The operation of hard disk 3 is controlled by SCSI commands issued by SBP2 controller 7. SBP2 controller 7 interprets protocol transmitted by a remote SBP2 controller (not shown) through IEEE 1394 controller 9 and delivers the SCSI commands to hard disk controller 5.

Access controller 13 performs a certification process for a node on the IEEE 1394 serial bus. Access controller 13 includes node counter 17 for detecting a node, and GUID memory 19 for storing a global unique identification (GUID) for an IEEE 1394 node. The GUID certifies that the IEEE 1394 node has already passed a certification process for being an IEEE node. When IEEE 1394 nodes initiate an access request to configuration ROM 15, via IEEE 1394 cabling, access controller 13 examines corresponding configuration ROM data of each requesting node. Accordingly, access controller 13 generates a response packet for each respective node by reading the corresponding configuration ROM data from config. ROM data storage 15. The generated response packet is transmitted to the requesting node through IEEE 1394 controller 9 and IEEE 1394 I/F unit 11.

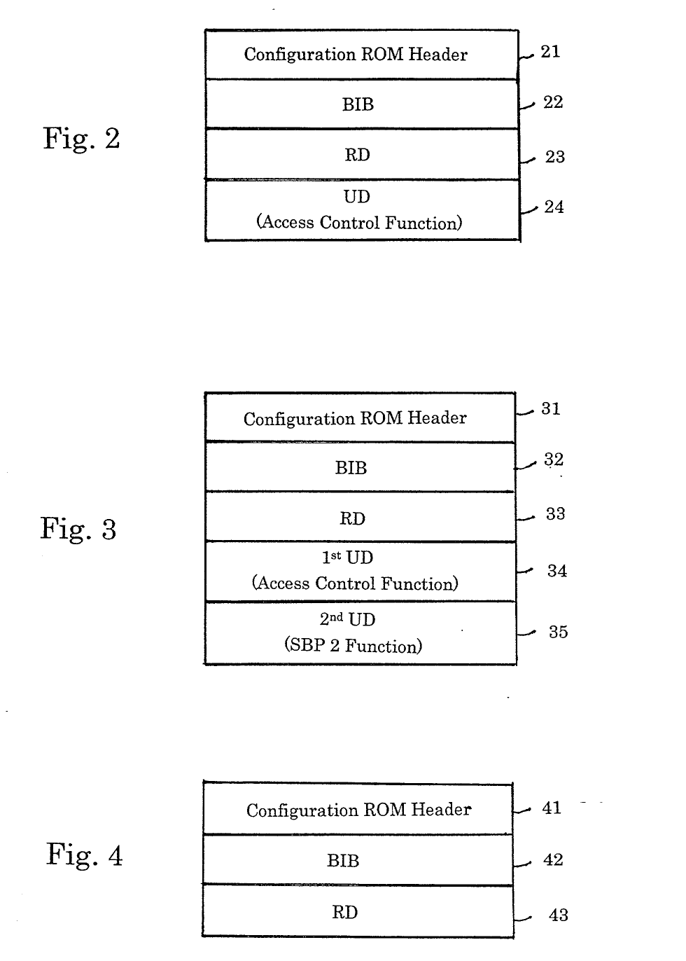

FIGS. 2-4 illustrate an example of the data contents in config. ROM data storage 15. Generally, config. ROM data includes a header for describing a data size of the config. ROM, a bus information block (hereinafter refers to as a “BIB”) for indicating a prescribed performance for a device corresponding to each bus, a root directory (hereinafter referred to as a “RD”) for storing additional information and a unit directory (hereinafter referred to as a “UD”) for describing a protocol specification ID in order to specify a particular communication protocol.

FIG. 2 illustrates a first data structure of a config. ROM 15 for storing an access control function, e.g., protocol for a certification process. The config. ROM data includes a header 21 for describing the data size of the config. ROM, a BIB 22, an RD 23 and a UD 24.

BIB 22, stores a code for indicating that IEEE 1394 is the protocol for the physical communication, a bit indicating the ability to control a node bus, and information indicating an inherent ID for the device with which config. ROM 15 is associated.

RD 23 stores a vendor ID for discriminating the vendor, and address offset information for indicating the communication protocol for UD 24. Furthermore, UD 24 stores information such as a command set, for discriminating an access control function.

FIG. 3 illustrates a second data structure of config. ROM 15 used to release the SBP2 function. The second structure includes a config. ROM Header 31, BIB 32, an RD 33, a first UD 34, and a second UD 35. Config. ROM Header 31, BIB 32, and RD 33 function as described above with reference to FIG. 2. First UD 34 discriminates an access control function and stores information of the applicable command set. Second UD 35 discriminates an SBP2 function and stores the command set corresponding to the SBP2 function.

FIG. 4 illustrates a third data structure of config. ROM 15. This structure includes a config. ROM header 41, a BIB 42, and an RD 43 which operate as described above with regard to FIG. 2. However, in contrast to FIGS. 2 and 3, this data structure has no publishing function, i.e., no UD is available as the address offset information for indicating the communication protocol.

IEEE 1394 Communication Protocol SB2 controls HDD device 10. Namely, if an IEEE 1394 node acquires config. ROM 15 having a structure including a UD, as shown in FIGS. 2 and 3, then an IEEE node 1394 may request access to HDD device 10 for data communication. Thus, communication protocol SB2 permits access to HDD device 10 when the IEEE 1394 node acquires a config. ROM data structure as shown in FIG. 3.

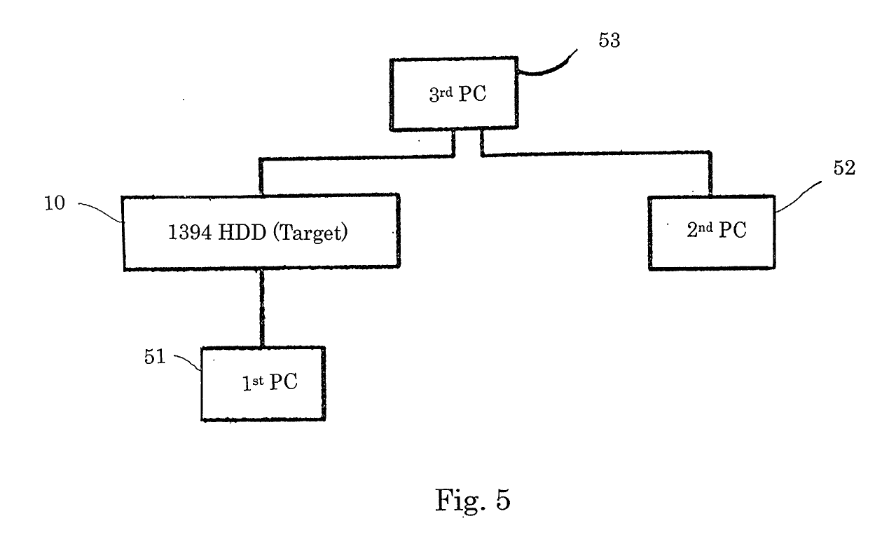

FIG. 5 illustrates an embodiment of an IEEE 1394 bus configuration among a plurality of IEEE 1394 nodes. IEEE 1394 nodes represented by a first PC 51, a second PC 52, and a third PC 53 correspond to nodes on the IEEE 1394 bus. The IEEE 1394 bus couples first PC 51 and third PC 53 to 1394 HDD 10. All nodes include an IEEE 1394 I/F (not shown) and an IEEE 1394 controller (not shown) for coupling the respective node to the IEEE 1394 bus. In this embodiment, 1394 HDD device 10 is initialized to release a config. ROM data structure as shown in FIG. 2, for communicating the access control function described in UD 24.

When HDD device 10 is coupled to the IEEE 1394 bus, each IEEE 1394 node on the IEEE 1394 bus detects a bus reset. Following the bus reset a parent-child relationship among the nodes on the IEEE 1394 bus is determined through a tree discrimination process. In this process, each node performs a self-identification (ID) by first recognizing a device construction. Then, beginning with the remotest child, each node sequentially broadcasts a self-ID packet over the IEEE 1394 bus. Upon completion of the tree discrimination process, further data communications among the nodes may be performed. Thus, each of first PC 51, second PC 52, and third PC 53 as IEEE 1394 nodes may then attempt to acquire the respective config. ROM data of the other IEEE 1394 nodes. For example, first PC 51 may perform a reading operation of the config. ROM data for respective nodes on the bus by reading config. ROM data for HDD device 10, second PC 52, and third PC 53.

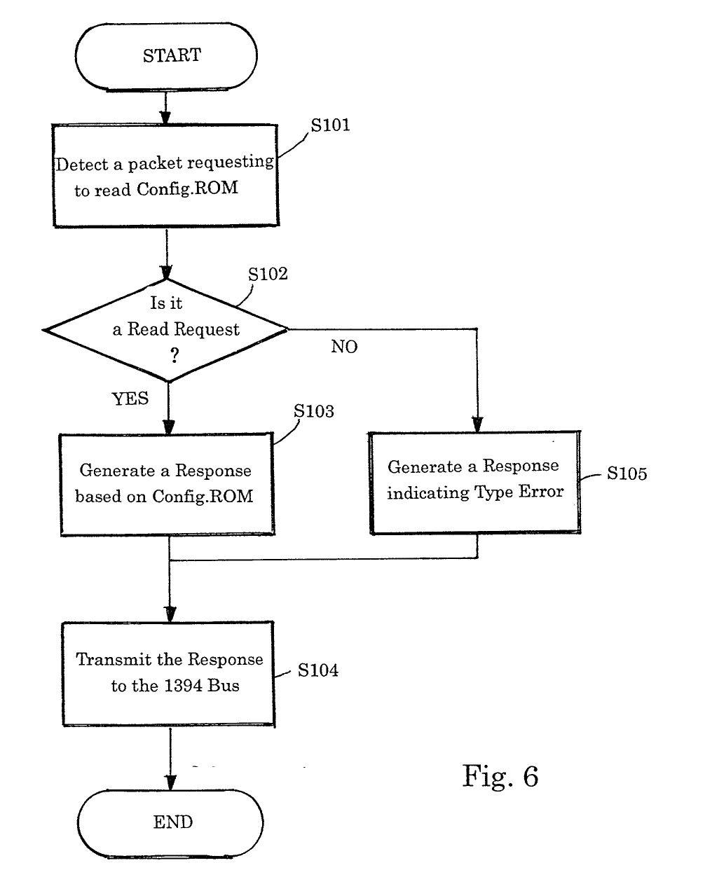

FIG. 6 illustrates the processing of a reading request of config. ROM 15 performed by HDD device 10. HDD device 10 executes this process when any of the IEEE 1394 nodes represented by first PC 51, second PC 52, or third PC 53 has not performed the certification process. For example, if HDD device 10 receives a read request of its config. ROM 15 from first PC 51, then access controller 13 of HDD device 10 detects receipt of the request packet from first PC 51 requesting to read config. ROM 15 (step S101). Access controller 13 interprets the command of the request packet to determine whether the instructed command is a read request (step S102).

If the request packet is interpreted as a read request (step S102, YES), then access controller 13 releases access control function 24 by generating a response packet containing relevant response data. Access controller 13 generates response packet data by calculating an offset based on the config. ROM contents as shown in FIG. 2 (step S103). Access controller 13 transmits the generated response packet to the IEEE 1394 bus through IEEE 1394 I/F unit 11 (step S104).

Processing the request for reading the config. ROM space may be performed in a unit of 4 bytes. First PC 51 interprets the size of the config. ROM according to header 21 and repeats acquisition of the config. ROM data contents by shifting the addresses for the read request until the entire contents in config. ROM 15 have been acquired. When first PC 51 has acquired the entire contents of the config. ROM, HDD device 10 is recognized as an IEEE 1394 node that has the access control function. Thus, this recognition occurs following acquisition of the whole contents of the config. ROM 15.

At step S102, if PC 51 interprets the request packet as corresponding to an instruction other than a read request (step S102, NO), access controller 13 of first PC 51 generates a response packet for indicating a type error by determining that the instructed command in the request packet is wrong (step S105). The generated type error response packet is transmitted to the IEEE 1394 bus through IEEE 1394 I/F unit 11 (step S104). Similarly, the second node, i.e., second PC 52, and the third node, i.e., third PC 53, each read the contents of the config. ROM in HDD device 10 by the same process.

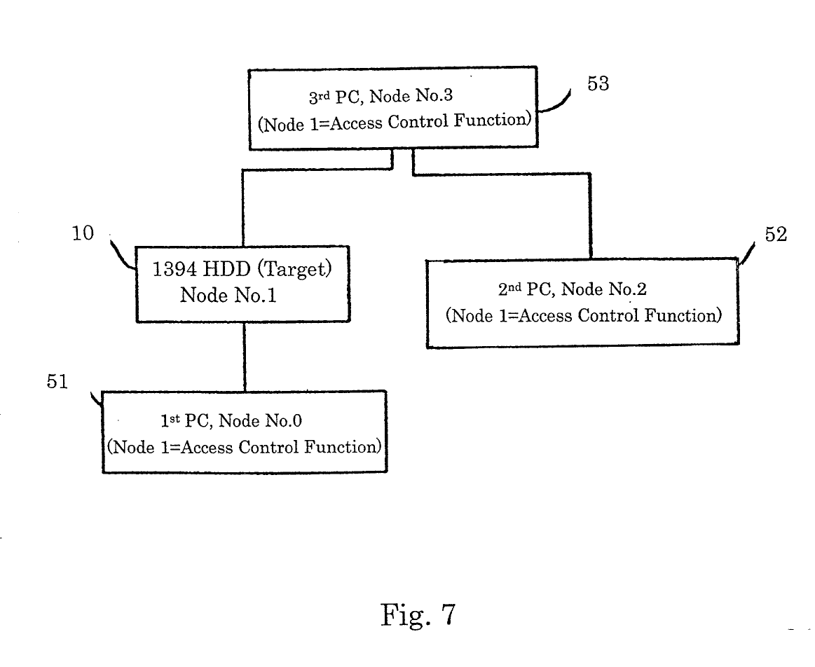

FIG. 7 illustrates a status of the node connection when each node completes reading the data of the config. ROM 15 of target node 10. The IEEE 1394 nodes represented by first PC 51, second PC 52 and third PC 53, respectively, request access to the target node of HDD device 10 and recognize that target node 10 located at node number “1.” Thus, each of first PC 51, second PC 52, and third PC 53 has an access control function.

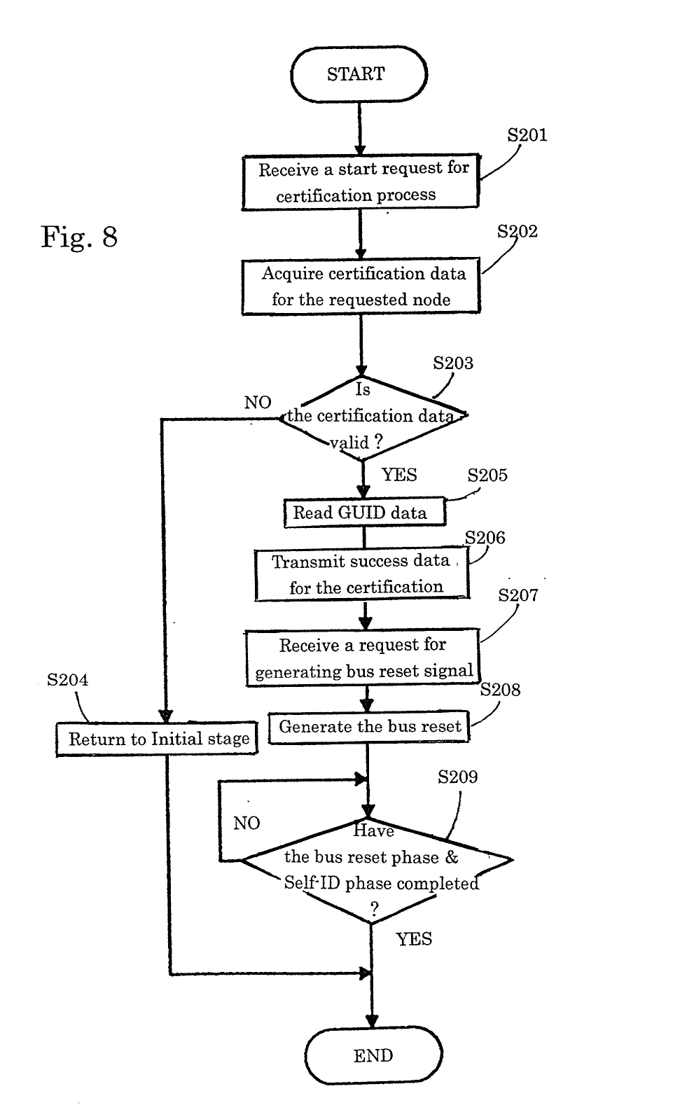

FIG. 8 shows a flow diagram illustrating the operation of access controller 13 when HDD device 10 receives a request for executing the certification process from any node on the IEEE 1394 bus. The requester node, in this case second PC 52 located at node number “2,” transmits a request for starting the certification process to the HDD device 10 to the instructed address identified by the data described in the access control function 24 of the acquired config. ROM during the process explained in FIG. 7. When access controller 13 receives the request for starting the certification process (step S201), access controller 13 acquires certification data, i.e., a password, from the requester node (step S202).

Next, IEEE 1394 controller 9 confirms whether or not the acquired certification data coincide with a preliminary registered certification data by examining whether or not the acquired certification data is valid (step S203). If the acquired certification data does not coincide with the preliminary registered certification data, i.e., the acquired certification data is not valid (step S203, NO), access controller 13 returns to the initial stage (step S204). Thus, the certification process is terminated.

On the other hand, if the acquired certification data coincides with the preliminary registered certification data, i.e., the acquired certification data is valid (step S203, YES), access controller 13 starts the certification process by acquiring the GUID for second PC 52. The requester initiates a request for starting the certification process (step S205). Access controller 13 reads the GUID data from second PC 52 corresponding to node 2 and stores the acquired GUID in the GUID memory 19. After storing the GUID, access controller 13 transmits a success notice indicating a successful certification process, to second PC 52 located at the requester node corresponding to node 2 (step S206).

Following receipt of the success notice, second PC 52 transmits a request for starting a bus reset signal. When HDD 10 of the target node receives the request (step S207), access controller 13 transmits a bus reset signal to other nodes coupled to the IEEE 1394 bus (step S208). The certification process terminates once the bus reset phase and an accompanying receiving phase of a self-ID packet are complete (step S209, YES). Usually, in order to prevent important data from being altered, the target node may allow access from a single node during a particular time frame. In other words, the certification process consistent with the invention allows a single node exclusive access to the target node.

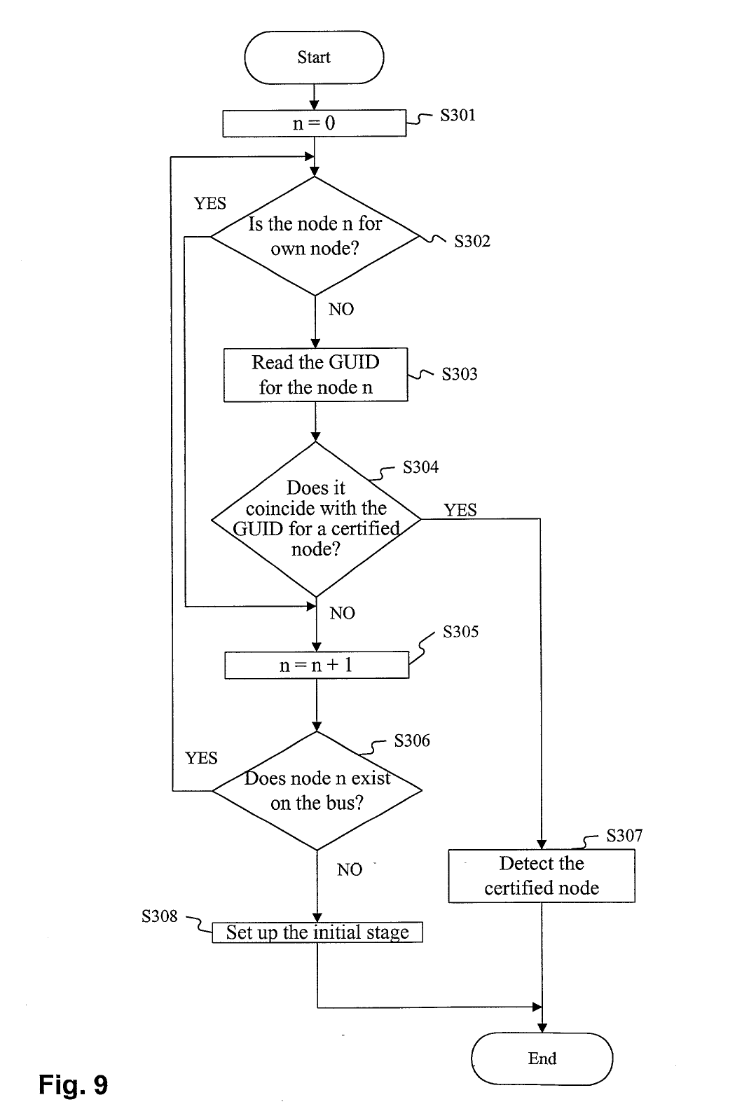

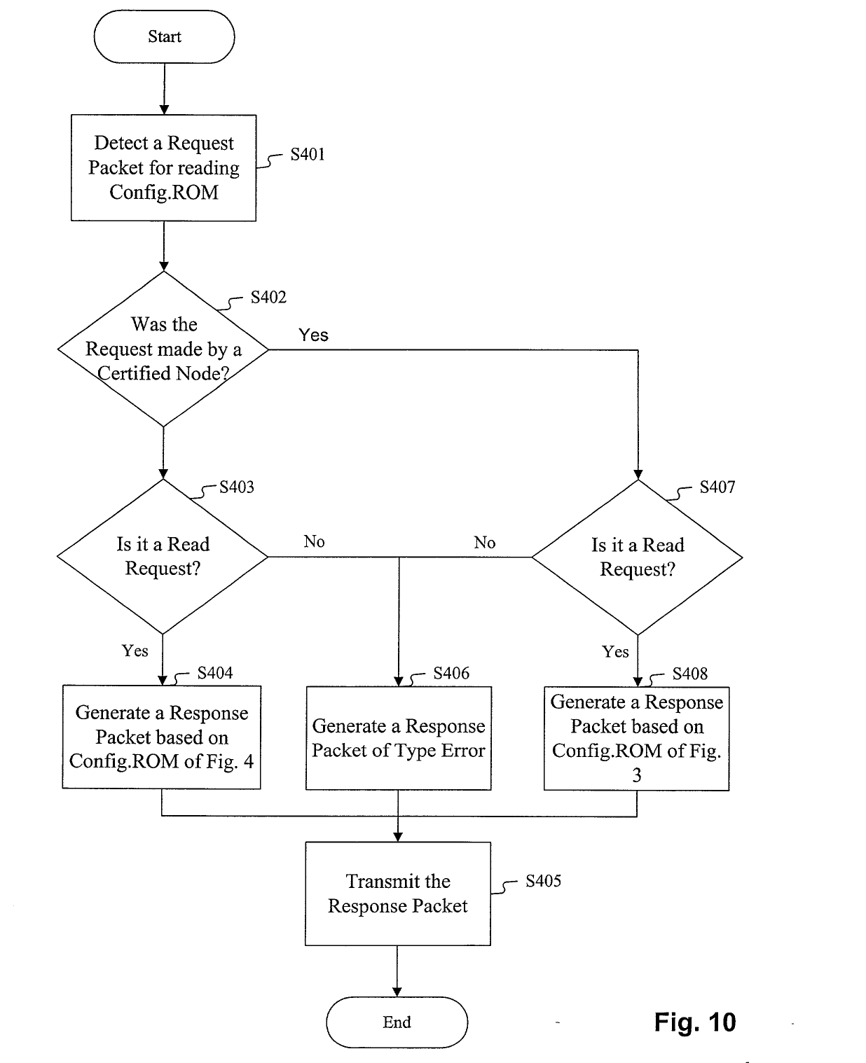

FIG. 9 illustrates a process for detecting a certified node following a completed bus reset. Node counter 17 in access controller 13 of 1394 HDD 10 is initialized. Specifically, a variable “n” in node counter 17 is set to zero (“0”) (step S301). Node counter 17 detects the certified node after the bus reset in accordance with the function of access controller 13. Then, access controller 13 confirms that the variable “n” in node counter 17 indicates a node allotted for another node device other than 1394 HDD 10 of the target node (step 302). If access controller 13 confirms that the counter value does not coincide with the allotted node number of 1394 HDD device 10 (step 302, NO), then access controller 13 acquires and reads the GUID for the node corresponding to node “n” (step 303).

Next, access controller 13 examines the acquired GUID to determine whether the acquired GUID coincides with the GUID for the certified node (step 304). If the acquired GUID does not coincide with the GUID for the certified node (step S304, NO), the variable “n” in node counter 17 is incremented by one, i.e., n=n+1 (step S305). Access controller 13, then determines whether the incremented node “n+1” exists on the bus (step 306). If the incremented node “n+1” exists on the bus (step S306, YES), then the process returns to step S302 in order to acquire a next GUID for a next node. Accordingly all GUIDs for each node in the bus may be acquired using this process.

Up to this point, second PC 52 (node No. 2) has performed the certification process, therefore, when access controller 13 acquires the GUID for node “2” by repeating steps S302 to S306, and the acquired GUID coincides with the preliminary approved GUID for the certified node (step S304, YES), the target node detects second PC 52 (node No. 2) as the certified node (step S307). If all of the acquired GUID from the nodes on the bus connection do not coincide with the approved GUID for the certified node (step S306, YES), processing returns to the initial stage (step S308) for completion. After detecting the certified node, the access controller 13 in the target node initiates a request for accessing the config. ROM space.

FIG. 10 shows a flow diagram illustrating the controlling process for access controller 13 accessing the config. ROM space in a 1394 HDD device after the HDD receives the accessing request.

After completing the certification process, first PC 51, second PC 52, and third PC 53 attempt to acquire the content data in the config. ROM of devices located at other nodes on the IEEE 1394 bus. For example, first PC 51 corresponding to node 0, transmits the read request packet to devices located at nodes 1, 2, and 3 requesting to read the respective config. ROM space. Access controller 13 corresponding to a device located at one of nodes 1, 2 or 3, detects the request packet for reading the config. ROM space from first PC 51 (step S401). In the embodiment, the transmitted and received request packet are normally used in the IEEE 1394 protocol. By interpreting the header of the request packet, access controller 13 determines whether or not the node transmitting the request packet is a certified node (step S402). In this example, first PC 51 of node 0 is not a certified node (step S402, NO). Accordingly, when it is confirmed that the request packet is a read request (step S403, YES), access controller 13 generates a response packet for a no release function based on the config. ROM data as shown in FIG. 4 (step S404). The generated response packet is then transmitted to first PC 51. First PC 51 receives the response packet and recognizes that 1394 HDD 10 of node 1-has no available function. Similarly, third PC 53 recognizes that 1394 HDD 10 of node 1 has no available function. Therefore, because there is no available function with respect to the IEEE 1394 bus, effectively, 1394 HDD does not exist.

Second PC 52 performs the certification process by reading the data of the config. ROM associated with 1394 HDD 10. As in the case of first PC 51, access controller 13 of 1394 HDD 10 detects the read request packet from second PC 52 for reading the config. ROM (step S401). By interpreting the header of the request packet, access controller 13 determines that the node transmitting the request packet is a certified node (step S402, YES). Next, access controller 13 confirms that the packet is the read request for reading the config. ROM data (step S407, YES), and access controller 13 generates a response packet by calculating an offset based on the config. ROM data structure used for releasing the access control function and the SBP2 function, as shown in FIG. 3 (step S408). The generated response packet is transmitted to the node of the second PC 52 (step S405).

By receiving the response packet, the second PC 52 recognizes that node 0 of 1394 HDD 10 includes both an access control function and an SBP2 function. Consequently, second PC 52 may perform normal processing based on the SBP2 protocol. On the other hand, if the received request is not the read request (steps S403, S407), access controller 13 of 1394 HDD 10 generates a response packet by indicating a type error (step S406). By receiving the response packet (step S405), second PC 52 recognizes that the read request was an error.

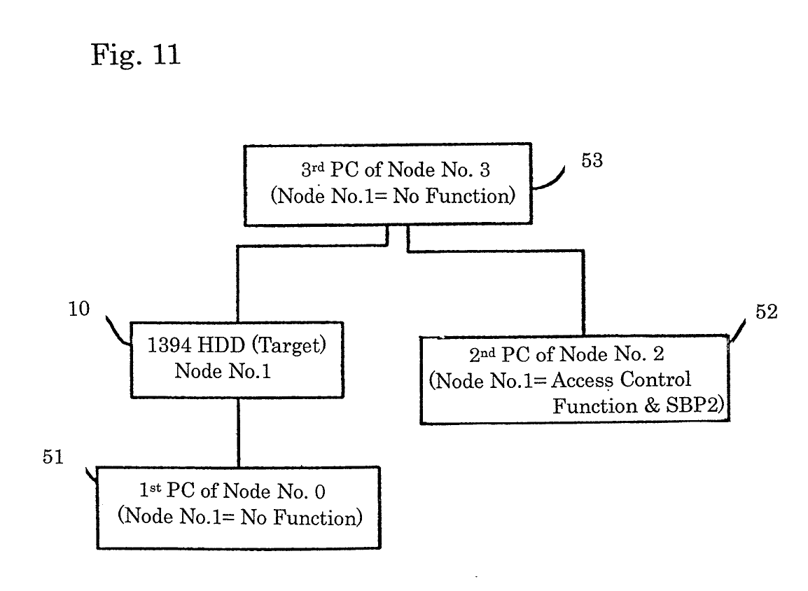

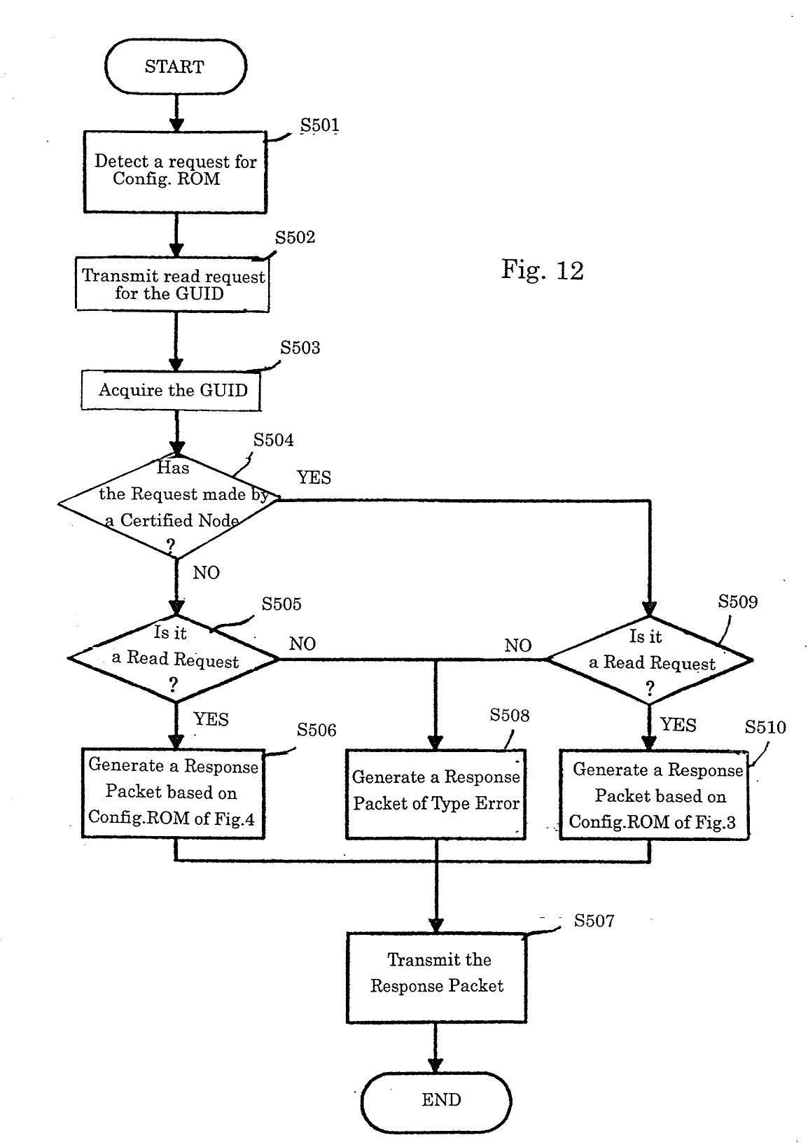

FIG. 11 illustrates the node connection after a single node corresponding to second PC 52 reads a particular config. ROM. Namely, target node 1394 HDD 10 releases config. ROM data that has no available function, as shown in FIG. 4, to first PC 51 and third PC 53. Conversely, 1394 HDD 10 releases config. ROM data having the access control function and the SBP2 function, as shown in FIG. 3, to the certified second PC 52. First PC 51 and third PC 53 recognize that 1394 HDD 10 of node 1 has no available function. On the other hand, second PC 52 recognizes both the access control function and the SBP2 function as the released function of 1394 HDD 10.

FIG. 12 shows a flow diagram illustrating a process for switching the config. ROM after the certification process is complete. In this embodiment, after completing the certification process, a bus device transmits the read request for reading the config. ROM before detecting the certified node. Thus, the bus device receives the read request after completing the bus reset as shown in FIG. 8.

For example, first PC 51 of node 0 transmits a packet for requesting to read the config. ROM of 1394 nodes corresponding to nodes 1, 2 and 3 after the bus reset. When access controller 13 of 1394 HDD 10 of node 1 detects the packet for requesting to read the config. ROM space from first PC 51 (step S501), access controller 13 transmits a read request for reading a GUID based on the node of the requester (step S502). First PC 51 sends the GUID as a reply to the requesting 1394 HDD. When first PC 51 accesses GUID memory 19 and acquires the GUID (step S503), first PC 51 interprets the request packet with reference to the acquired GUID (step S504) to determine whether or not the request packet has been transmitted from a certified node.

Because first PC 51 is not a certified node (step S504, NO), access controller 13 confirms whether the packet is a read request (step S505). If the packet is a read request (step S505, YES), access controller 13 generates a response packet by calculating an offset based on the config. ROM data structure that releases no available function, as shown in FIG. 4 (step S506). If the request packet is not a read request (step S505, NO), then access controller 13 generates a response packet by indicating a type error (step S508). The generated response packet is transmitted to PC 51. By receiving the response packet, PC 51 recognizes that 1394 HDD 10 of node 1 has no available function. Similarly, PC 53 also recognizes that 1394 HDD 10 of node 1 has no available function.

FIG. 12 also illustrates the flow of information where config. ROM data is read by a PC that has performed the certification process. At step S501, access controller 13 detects a packet from second PC 52 requesting to read the config. ROM space. Access controller 13 transmits a read request for reading a GUID based on the node number of the requester device, second PC 52 (step S502). Second PC 52 then transmits the GUID to the HDD (step S502).

When second PC 52 acquires the GUID (step S503), access controller 13 detects that second PC 52 is a certified node by interpreting the header of the request packet (step S504, YES). By confirming that the packet is a read request (step S509, YES), access controller 13 generates a response packet by calculating an offset based on the config. ROM data for releasing the access control function and the SBP2 function, as explained in FIG. 3 (step S510). The generated response packet is transmitted to the node corresponding to second PC 52 (step S507). Upon receiving the response packet, second PC 52 recognizes that the node corresponding to the HDD has the access control function and the SBP2 function. Consequently, second PC 52 may perform normal processing of the protocol of the SBP2 with respect to the HDD.

As explained above, the apparatus and method consistent with the present invention controls access to a target node of an electronic apparatus by switching config. ROM data, based upon the node requesting access to the target node. This enables a device to determine whether a certified node acquires a GUID after receiving a packet requesting to read the config. ROM.

In the above embodiments, the 1394 HDD device is explained as an electronic apparatus. However, the 1394 HDD device may also allow selective access to an associated PC. Further, the 1394 HDD device may function to switch the config. ROM having the SBP2 function and the config. ROM having no releasing function. Moreover, when releasing other functions, such as an AV/C or an internet protocol (IP) over the IEEE 1394 bus, it is also possible to switch to another config. ROM having a data structure as shown in FIG. 3.

Other embodiments of the present invention will be apparent to those skilled in the art from consideration of the specification and practice of the invention disclosed herein. For example, the invention is applicable to any type of electronic devices, such as a digital video disc (DVD) device and an MO device. It is intended that the specification and examples be considered as exemplary only, with a true scope and sprit of the invention being indicated by the following claims.

What is claimed is:

1. In a communication system, an electronic apparatus coupled to a target device and a plurality of accessing devices through a bus connection, the electronic apparatus comprising:
means for storing function data for allowing or prohibiting access to the target device;
means for communicating the function data of the target device to the plurality of accessing devices coupled through the bus connection;
means for detecting a request for reading the function data made by one of the plurality of accessing devices; and
means for selectively releasing a response providing either access allowing function data or access prohibiting function data based on a certification status of the requesting accessing device.

2. The electronic apparatus according to claim 1, further comprising:
means for performing a certification process for one of the plurality of accessing devices; and
means for judging whether the request for reading the function data has been made by one of the accessing devices having the certification, wherein a controlling means releases the response including the access allowing function data to one of the plurality of accessing devices when the judging means determines that the request has been made by one of the plurality of accessing devices having the certification.

3. The electronic apparatus according to claim 2, wherein:
the controlling means releases the access prohibiting function data to at least one of a plurality of accessing devices when the judging means determines that the request has been made by at least one of the plurality accessing devices having no certification.

4. The electronic apparatus according to claim 2, wherein the certification process performing means includes:
means for acquiring certification data for at least one of the plurality of accessing electronic apparatus;
means for transmitting success data to one of the plurality of accessing devices based on the acquired certification data; and
means for generating a bus reset signal to the bus connection for entering a bus reset phase.

5. The electronic apparatus according to claim 4, wherein the certification process performing means further includes:
means for counting a node number of each of the plurality of the accessing devices; and
means for correlating acquired certification data of one of the plurality of accessing devices having the counted node number and certification data of the electronic apparatus.

6. A target electronic device for coupling through a bus connection to a plurality of accessing devices, comprising:
means for detecting a request of one of the plurality of accessing devices for accessing the target electronic device;
means for acquiring GUID data for the accessing device;
means for comparing the acquired GUID data to preliminary GUID data stored in the target device; and
means for releasing an access allowing function data to the accessing device when the acquired GUID data coincides with the preliminary stored GUID data, and for releasing an access prohibiting function data when the acquired GUID data does not coincide with the preliminary stored GUID data.

7. In a system including a target apparatus having a communicating means and a plurality of electronic devices capable of communications with the target apparatus through the communicating means, the target apparatus comprising:
means for storing a first function data and a second function data;
means for performing a certification process for certifying the plurality of electronic devices;
means for detecting a request for reading function data of the target apparatus from one of the plurality of electronic devices;
means for judging whether the reading request is made by one of the plurality of electronic devices having a certification; and
means for transmitting the first function data if the judging means determines that the request was made by one of the plurality of electronic devices having the certification and transmitting the second function data if the judging means determines that the request was made by one of the plurality of electronic devices having no certification.

8. A method for controlling communication among a target electronic device serving as a target node and a plurality of electronic devices serving as accessing nodes and coupled to the target node through a serial bus connection, comprising the steps of:
storing function data in the target electronic device for authorizing access to the target node;
detecting a request for reading the function data from one of the plurality of accessing nodes;
determining whether the request is made by one of the plurality of accessing nodes having a certification; and
generating a response for releasing function data allowing access to the target node based on the determination.

9. A method for communicating data between a target node and a plurality of accessing nodes coupled to the target node through a bus, comprising the steps of:
performing a certification process for certifying one of the plurality of accessing nodes to access the target node;
detecting a request of one of the plurality of accessing nodes for accessing the target node;
judging whether the request is made by the certified node; and
transmitting access allowing data to the certified node.

10. The method according to claim 9, further including a step of transmitting access prohibiting data to the access requesting nodes that are not certified.

11. A method for communicating among a target device and a plurality of accessing devices coupled to the target device through a bus connection, comprising:
detecting a request of one of the plurality of accessing devices for accessing the target device;
acquiring GUID data for the requesting accessing device;
comparing to the acquired GUID data to preliminary GUID data stored in the target electronic apparatus;
releasing access allowing function data to the requesting accessing device when the acquired GUID data coincides with the preliminary GUID data; and
releasing access prohibiting function data to the requesting accessing device when the acquired GUID data does not coincide with the preliminary GUID data.

12. A system for communicating data among a plurality of devices coupled through a bus connection, comprising:
an electronic device, for selectively communicating stored function data of a second device to one of a plurality of third devices based on a certification status of the third device;
a target device, corresponding to the second device, for acquiring GUID data from one of the plurality of third devices and releasing function data based on a comparison between the acquired data and preliminary stored data; and
a plurality of accessing devices, corresponding to the third device, for receiving function data of the target device based an authorization performed by at least one of the electronic device and target device as a result of a read request.

13. The system of claim 12, wherein the electronic device further comprises:
means for performing a certification process for one of the plurality of accessing devices; and
means for judging whether a request for reading the function data has been made by one of the accessing devices having the certification, wherein a controlling means releases the response including the access allowing function data to one of the plurality of accessing devices when the judging means determines that the request has been made by one of the plurality of accessing devices having the certification.

14. The system of claim 12, wherein the acquired data and preliminary stored data of the target device correspond to GUID data.
